(19) United States
(12) Patent Application Publication
(10) Pub. No.: US 2026/0155728 A1
(43) Pub. Date: Jun. 4, 2026

(54) POWER SUPPLY AND OPERATING METHOD THEREOF

(71) Applicant: Delta Electronics, Inc., Taoyuan City (TW)

(72) Inventors: Hong-Jyun Chen, Taoyuan City (TW); Cheng-Chan Hsu, Taoyuan City (TW)

(21) Appl. No.: 19/190,343

(22) Filed: Apr. 25, 2025

Related U.S. Application Data
(60) Provisional application No. 63/726,883, filed on Dec. 2, 2024.

(30) Foreign Application Priority Data
Mar. 31, 2025 (CN) 202510388008.8

(51) Int. Cl. H02M 1/00

(52) U.S. Cl. CPC H02M 1/0022; H02M 1/0025

(57) ABSTRACT

A power supply and an operating method are provided. A detection circuit detects the input voltage and provides a detection result. A feedback circuit detects the output voltage and the output current and generates a feedback signal. A reference voltage generation circuit generates a reference voltage according to the input voltage and the feedback signal. A control signal generation circuit generates a control signal according to the reference voltage. When the detection circuit detects a duration during which the input voltage is less than a voltage threshold is longer than the time threshold, the reference voltage generation circuit adjusts the reference voltage within a hold-up time according to the detection result, the control signal generation circuit generates the control signal within the hold-up time according to the reference voltage to configure the power conversion circuit to decrease the output current.

### CROSS-REFERENCE TO RELATED APPLICATION

This application claims the benefit of U.S. Provisional Application No. 63/726,883 filed on Dec. 2, 2024, and entitled “POWER CONVERTER AND OPERATING METHOD THEREOF”, the entirety of which is hereby incorporated by reference. This application also claims the priority to China Patent Application No. 202510388008.8 filed on Mar. 31, 2025, the entirety of which is hereby incorporated by reference.

### FIELD OF THE INVENTION

The present disclosure relates to a power supply and more particularly to the power supply and an operating method thereof with enhancing system stability.

### BACKGROUND OF THE INVENTION

The power system provides power to the load such as servers. In order to prevent power supply failures, the power system typically includes two or more power supplies connected in parallel to provide power to the servers. For example, a redundant power system includes a plurality of power supplies. The plurality of power supplies provide power to the servers individually or concurrently.

When one of the plurality of power supplies requires replacement, the power supply is removed. Namely, at least a portion of the input power of the power system is removed so as to stop providing power. At the moment when the power supply stop providing power, a significant voltage drop may occur at the load corresponding to the remaining power supply still in operation. Consequently, the power system cannot provide stable power. The load may be operated abnormally, or a load failure may be occurred.

Therefore, there is a need of providing a power supply and an operating method of the power supply to obviate the drawbacks encountered from the prior arts.

### SUMMARY OF THE INVENTION

The object of the present disclosure is to provide a power supply and an operating method of the power supply. The power supply of the present disclosure includes the reference voltage generation circuit and the control signal generation circuit. When the detection circuit detects the duration during the input voltage less than the voltage threshold is greater than the time threshold, the reference voltage generation circuit adjusts the reference voltage to the predetermined reference voltage value within the hold-up time. The control signal generation circuit accordingly controls the power conversion circuit to gradually decrease the output current according to the control signal. Compared to the conventional power system, the power system utilizing the power supply of the present disclosure decreases the output current within the hold-up time. Consequently, the output current of other power supplies is increased correspondingly. The output voltage provided by the plurality of power supplies is maintained. The voltage fluctuations at the load side are minimized effectively when the power supply of the present disclosure stops providing power after the hold-up time. Consequently, the power system utilizing the power supply of the present disclosure has advantages of enhancing stability and safety and ensuring that the load operates normally.

In accordance with an aspect of the present disclosure, a power supply is provided. The power supply is configured to be connected with one or more other power supplies for providing power to a load. The power supply includes a power conversion circuit, a detection circuit, a feedback circuit, a reference voltage generation circuit and a control signal generation circuit. The power conversion circuit is configured to receive and convert an input voltage to an output voltage and an output current. The detection circuit is connected with an input terminal of the power conversion circuit for detecting the input voltage and accordingly providing a detection result. The feedback circuit is connected with an output terminal of the power conversion circuit for detecting the output voltage and the output current and accordingly generating a feedback signal. The reference voltage generation circuit is connected with the power conversion circuit, the detection circuit and the feedback circuit for generating a reference voltage according to the input voltage and the feedback signal. When the detection circuit detects a duration during which the input voltage is less than a voltage threshold is longer than a time threshold, the reference voltage generation circuit adjusts the reference voltage within a hold-up time according to the detection result. The control signal generation circuit is connected between the reference voltage generation circuit and the power conversion circuit for generating a control signal according to the reference voltage. When the detection circuit detects the duration during which the input voltage is less than the voltage threshold is longer than the time threshold, the control signal generation circuit generates the control signal within the hold-up time according to the reference voltage to configure the power conversion circuit to decrease the output current.

In accordance with another aspect of the present disclosure, an operating method of a power supply is provided. The power supply is configured to be connected with one or more other power supplies for providing power to a load. The operating method includes the following steps. Firstly, an input voltage is received and converted to an output voltage and an output current with a power conversion circuit. Then, the input voltage is detected and a detection result is accordingly provided with a detection circuit. Then, the output voltage and the output current are detected and a feedback signal is generated with a feedback circuit. Then, a reference voltage is generated according to the input voltage and the feedback signal with a reference voltage generation circuit. Then, a control signal is generated according to the reference voltage with a control signal generation circuit. When the detection circuit detects a duration during which the input voltage is less than a voltage threshold is longer than the time threshold, the reference voltage generation circuit adjusts the reference voltage within a hold-up time according to the detection result, the control signal generation circuit generates the control signal within the hold-up time according to the reference voltage to configure the power conversion circuit to decrease the output current.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the power supply of the power system according to an embodiment of the present disclosure;

FIG. 2 is a schematic detail circuit diagram illustrating the second power supply of the power system as shown in FIG. 1; and

FIG. 3 is a schematic waveform diagram illustrating portion of parameter of the power system as shown in FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

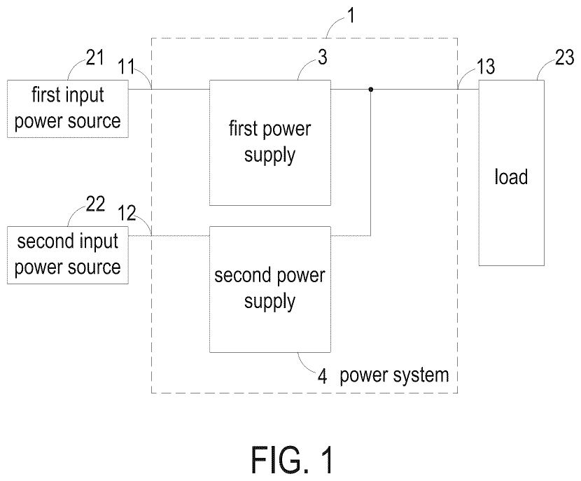

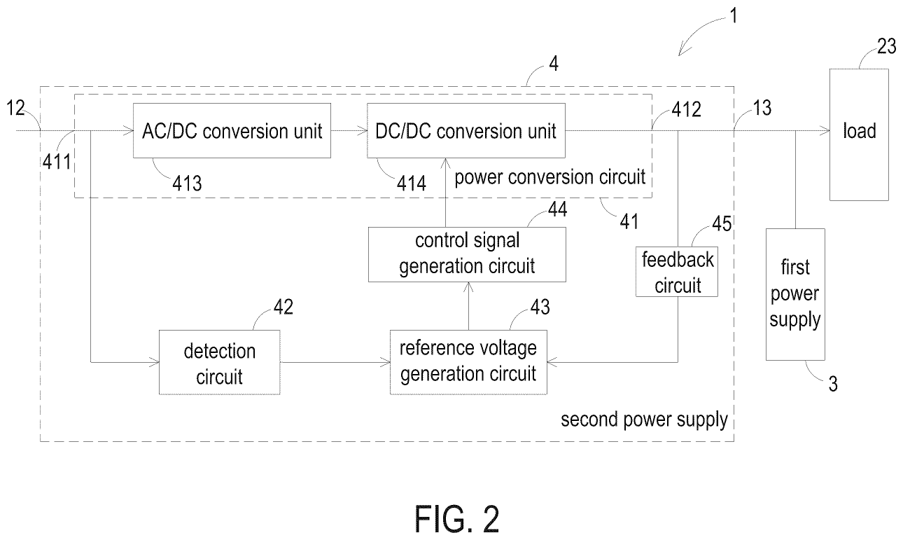

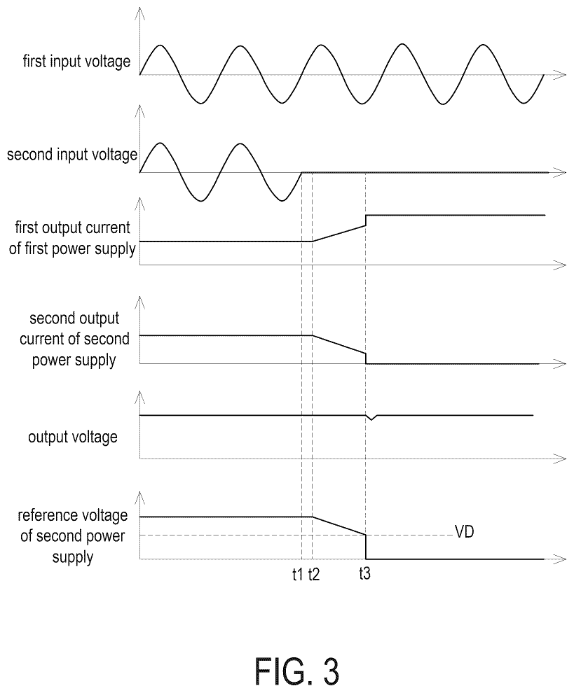

FIG. 1 is a schematic circuit diagram illustrating the power supply of the power system according to an embodiment of the present disclosure. FIG. 2 is a schematic detail circuit diagram illustrating the second power supply of the power system as shown in FIG. 1. FIG. 3 is a schematic waveform diagram illustrating portion of parameter of the power system as shown in FIG. 1. The power system 1 of the present disclosure includes a plurality of power supplies. For description easily, the power system 1 includes two power supplies. When the power system 1 includes more than two power supplies, it may still operate in the same or a similar manner. As shown in FIG. 1, the power system 1 of the present disclosure is connected with a first input power source 21, a second input power source 22 and a load 23. The first input power source 21 and the second input power source 22 are AC power sources or DC power sources. In this embodiment, both the first input power source 21 and the second input power source 22 are AC power sources.

The power system 1 includes a first main input terminal 11, a second main input terminal 12, a main output terminal 13, a first power supply 3 and a second power supply 4. The power system 1 receives a first input voltage provided by the first input power source 21 through the first main input terminal 11. The power system 1 receives a second input voltage provided by the second input power source 22 through the second main input terminal 12. The first power supply 3 is connected with the first main input terminal 11 to receive and convert the first input voltage provided by the first input power source 21 into a first output voltage and a first output current. The second power supply 4 is connected with the second main input terminal 12 to receive and convert the second input voltage provided by the second input power source 22 into a second output voltage and a second output current. The first power supply 3 and the second power supply 4 are connected with each other in parallel. The first output voltage and the second output voltage are provided to the load 23 through the main output terminal 13 collaboratively.

As shown in FIG. 2, the second power supply 4 includes a power conversion circuit 41, a detection circuit 42, a reference voltage generation circuit 43, a control signal generation circuit 44 and a feedback circuit 45. For description easily, other components of the second power supply 4 are omitted in FIG. 2. However, additional circuit components may be added or removed according to requirement. The power conversion circuit 41 is connected between the second main input terminal 12 and the main output terminal 13. The power conversion circuit 41 includes an input terminal 411, an output terminal 412, an AC/DC conversion unit 413 and a DC/DC conversion unit 414. The input terminal 411 of the power conversion circuit 41 is connected with the second main input terminal 12. The output terminal 412 of the power conversion circuit 41 is connected with the main output terminal 13. The power conversion circuit 41 receives and converts the second input voltage provided by the second input power source 22 through the input terminal 411. The power conversion circuit 41 outputs a second output voltage and a second output current to the load 23 through the output terminal 412. The AC/DC conversion unit 413 is connected between the input terminal 411 and the DC/DC conversion unit 414. The AC/DC conversion unit 413 converts the second input voltage in AC form into a DC intermediate voltage. The DC/DC conversion unit 414 is connected between the AC/DC conversion unit 413 and the output terminal 412. The DC/DC conversion unit 414 converts the DC intermediate voltage into the second output voltage and the second output current in DC form.

The detection circuit 42 is connected with the input terminal 411 of the power conversion circuit 41 to detect the second input voltage and accordingly provide a detection result. The feedback circuit 45 is connected with the output terminal 412 of the power conversion circuit 41 to detect the second output voltage and the second output current and accordingly generate a feedback signal. The reference voltage generation circuit 43 is connected with the detection circuit 42 and the feedback circuit 45. The reference voltage generation circuit 43 detects the second input voltage according to the detection result provided by the detection circuit 42 and generates a reference voltage according to the feedback signal generated from the feedback circuit 45 correspondingly.

When the detection circuit 42 detects a duration during which the second input voltage is less than a voltage threshold is shorter than or equal to a time threshold, the detection circuit 42 detects that the second input power source 22 provides power normally to the second power supply 4. When the reference voltage generation circuit 43 detects that the second output voltage is decreased according to the feedback signal generated by the feedback circuit 45, the reference voltage generation circuit 43 sets the control signal generation circuit 44 to generate a control signal according to the feedback signal correspondingly. For example, the duty cycle of the pulse width modulation control signal format of the DC/DC conversion unit 414 is adjusted. The DC/DC conversion unit 414 is controlled to increase the second output voltage. When the reference voltage generation circuit 43 detects that the second output voltage is increased according to the feedback signal generated by the feedback circuit 45, the reference voltage generation circuit 43 sets the control signal generation circuit 44 to generate a control signal according to the feedback signal correspondingly. The DC/DC conversion unit 414 is controlled to decrease the second output voltage.

When the detection circuit 42 detects a duration during which the second input voltage is less than a voltage threshold is longer than the time threshold, the detection circuit 42 detects that the second input power source 22 will not provide power normally to the second power supply 4. As shown in FIG. 3, between the time t1 and the time t2, the second input voltage of the second input power source 22 is zero. For example, the second input power source 22 and the second power supply 4 are disconnected with each other, or the second input power source 22 does not provide power normally. Under this circumstance, the reference voltage generation circuit 43 gradually decreases the reference voltage to a predetermined reference voltage value VD within a hold-up time according to the detection result generated from the detection circuit 42. As shown in FIG. 3, the hold-up time is between the time t1 and the time t3. The reference voltage generated by the reference voltage generation circuit 43 is gradually decreased to the predetermined reference voltage value VD.

In an embodiment, when the second input power source 22 provides an AC input voltage of 110V at 60 Hz, the voltage threshold is set to 30V, and the time threshold is set to 2 ms. In some embodiments, the voltage threshold and time threshold can be adjusted according to the characteristics of the input power signal of the second input power source. Consequently, the detection circuit 42 detects whether the second input power source provides power normally.

The control signal generation circuit 44 is connected between the reference voltage generation circuit 43 and the DC/DC conversion unit 414 of the power conversion circuit 41. The control signal generation circuit 44 generates a control signal according to the reference voltage provided by the reference voltage generation circuit 43 to control the operation of the DC/DC conversion unit 414 of the power conversion circuit 41. When the detection circuit 42 detects that the second input power source 22 provides power normally, and the reference voltage generation circuit 43 detects that the second output voltage is decreased according to the feedback signal generated by the feedback circuit 45, the control signal generated by the control signal generation circuit 44 controls the DC/DC conversion unit 414 to increase the second output voltage. When the reference voltage generation circuit 43 detects that the second output voltage is increased according to the feedback signal generated by the feedback circuit 45, the control signal generated by the control signal generation circuit 44 controls the DC/DC conversion unit 414 to decrease the second output voltage.

When the detection circuit 42 detects a duration during which the second input voltage is less than a voltage threshold is longer than the time threshold, the detection circuit 42 detects that the second input power source 22 will not provide power normally to the second power supply 4. The reference voltage generation circuit 43 decreases the reference voltage to a predetermined reference voltage value VD. The control signal generation circuit 44 generates the control signal to control the DC/DC conversion unit 414 to decrease the second output voltage. As shown in FIG. 3, between the time t2 and the time t3, the output voltage provided by the first power supply 3 and the second power supply 4 is maintained, and the second output current provided by the second power supply 4 is decreased.

In this embodiment, the detailed circuit of the first power supply 3 may be similar to or different from the detailed circuit of the second power supply 4, and the second power supply 4 is capable of operating in the manner described above regardless.

As shown in FIG. 3, the first input voltage received by the first power supply 3, the second input voltage received by the second power supply 4, the first output current of the first power supply 3, the second output current of the second power supply 4, the output voltage provided by the first power supply 3 and second power supply 4 and the reference voltage within the second power supply 4 from up to bottom. As shown in FIG. 3, at the time t1, the second input power source 22 is disconnected from the second power supply 4 or the second input power source 22 cannot provide power normally. Namely, the second input voltage is 0V. Between the time t1 and the time t2, the detection circuit 42 of the second power supply 4 detects that the second input power source 22 does not provide power normally to the second power supply 4. For example, as described in the previous embodiment, when the duration during which the second input voltage is less than the voltage threshold (30V) is longer than the time threshold (2 ms), the reference voltage of the second power supply 4 is controlled to decrease. Between the time t2 and the time t3, the reference voltage generation circuit 43 decreases the reference voltage to the predetermined reference voltage value VD. The second output current of the second power supply 4 is decreased, and the first output current of the first power supply 3 is increased correspondingly. The output voltage provided by the first power supply 3 and the second power supply 4 is maintained. After the time t3, the second power supply 4 stops to provide power. The output voltage provided by the first power supply 3 and the second power supply 4 only generates a brief and minor voltage drop.

In this embodiment, the control signal generation circuit 44 generates the control signal according to the increasing of the reference voltage so as to control the power conversion circuit 41 to increase the output voltage and/or the output current correspondingly. Moreover, the control signal generation circuit 44 generates the control signal according to the decreasing of the reference voltage to control the power conversion circuit 41 to decrease the output voltage and/or the output current correspondingly. In one embodiment, the control signal generation circuit 44 generates the control signal according to the increasing of the reference voltage so as to control the power conversion circuit 41 to decrease the output voltage and/or the output current correspondingly. Moreover, the control signal generation circuit 44 generates the control signal according to the decreasing of the reference voltage to control the power conversion circuit 41 to increase the output voltage and/or the output current correspondingly. In this embodiment, when the detection circuit 42 detects the duration during which the input voltage is less than the voltage threshold is longer than the time threshold, the reference voltage generation circuit 43 gradually decreases the reference voltage to a predetermined reference voltage value VD within the hold-up time. The control signal generation circuit 44 generates the control signal according to the reference voltage which is increased to control the DC/DC conversion unit 414 to decrease the second output voltage.

As mentioned above, the power supply of the present disclosure includes the reference voltage generation circuit and the control signal generation circuit. When the detection circuit detects the duration during which the input voltage is less than the voltage threshold is longer than the time threshold, the reference voltage generation circuit adjusts the reference voltage to the predetermined reference voltage value within the hold-up time. The control signal generation circuit accordingly controls the power conversion circuit to gradually decrease the output current according to the control signal. A significant voltage drop may occur to the conventional power system when the power supply stop providing power. Compared to the conventional power system, the power system utilizing the power supply of the present disclosure decreases the output current within the hold-up time. Consequently, the output current of other power supplies is increased correspondingly. The output voltage provided by the plurality of power supplies is maintained. The voltage fluctuations at the load side are minimized effectively when the power supply of the present disclosure stops providing power after the hold-up time. Consequently, the power system utilizing the power supply of the present disclosure has advantages of enhancing stability and safety and ensuring that the load operates normally.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply configured to be connected with one or more other power supplies for providing power to a load, comprising:
a power conversion circuit configured to receive and convert an input voltage to an output voltage and an output current;
a detection circuit connected with an input terminal of the power conversion circuit for detecting the input voltage and accordingly providing a detection result;
a feedback circuit connected with an output terminal of the power conversion circuit for detecting the output voltage and the output current and accordingly generating a feedback signal;
a reference voltage generation circuit connected with the power conversion circuit, the detection circuit and the feedback circuit for generating a reference voltage according to the input voltage and the feedback signal, wherein when the detection circuit detects a duration during which the input voltage is less than a voltage threshold is longer than a time threshold, the reference voltage generation circuit adjusts the reference voltage within a hold-up time according to the detection result; and
a control signal generation circuit connected between the reference voltage generation circuit and the power conversion circuit for generating a control signal according to the reference voltage, wherein when the detection circuit detects the duration during which the input voltage is less than the voltage threshold is longer than the time threshold, the control signal generation circuit generates the control signal within the hold-up time according to the reference voltage to configure the power conversion circuit to decrease the output current.

2. The power supply according to claim 1, wherein the reference voltage generation circuit gradually decreases the reference voltage to a predetermined reference voltage within the hold-up time according to the detection result.

3. The power supply according to claim 1, wherein the reference voltage generation circuit gradually increases the reference voltage to a predetermined reference voltage value within the hold-up time according to the detection result.

4. The power supply according to claim 1, wherein when the detection circuit detects the duration during which the input voltage is less than the voltage threshold is shorter than or equal to the time threshold, and the reference voltage generation circuit detects that the output voltage is decreased according to the feedback signal generated by the feedback circuit, the reference voltage generation circuit increases the reference voltage, and the control signal generated by the control signal generation circuit accordingly controls the power conversion circuit to increase the output voltage.

5. The power supply according to claim 1, wherein when the detection circuit detects the duration during which the input voltage is less than the voltage threshold is shorter than or equal to the time threshold, and the reference voltage generation circuit detects that the output voltage is increased according to the feedback signal generated by the feedback circuit, the reference voltage generation circuit decreases the reference voltage, and the control signal generated by the control signal generation circuit accordingly controls the power conversion circuit to decrease the output voltage.

6. The power supply according to claim 1, wherein the power conversion circuit further comprises an AC/DC conversion unit and a DC/DC conversion unit, the AC/DC conversion unit is connected between the input terminal and the DC/DC conversion unit, the AC/DC conversion unit converts the input voltage in AC form to a DC intermediate voltage, the DC/DC conversion unit is connected between the AC/DC conversion unit and the output terminal, the DC/DC conversion unit converts the DC intermediate voltage to the output voltage and the output current in DC form.

7. An operating method of a power supply, the power supply configured to be connected with one or more other power supplies for providing power to a load, comprising:
receiving and converting an input voltage to an output voltage and an output current with a power conversion circuit;
detecting the input voltage and accordingly providing a detection result with a detection circuit;
detecting the output voltage and the output current and accordingly generating a feedback signal with a feedback circuit;
generating a reference voltage according to the input voltage and the feedback signal with a reference voltage generation circuit;
generating a control signal according to the reference voltage with a control signal generation circuit; and
when the detection circuit detects a duration during which the input voltage is less than a voltage threshold is longer than the time threshold, the reference voltage generation circuit adjusts the reference voltage within a hold-up time according to the detection result, the control signal generation circuit generates the control signal within the hold-up time according to the reference voltage to configure the power conversion circuit to decrease the output current.

8. The operating method according to claim 7, wherein the operating method further comprises: when the detection circuit detects the duration during which the input voltage is less than the voltage threshold is longer than the time threshold, the reference voltage generation circuit gradually decreases the reference voltage to a predetermined reference voltage within the hold-up time according to the detection result.

9. The operating method according to claim 7, wherein the operating method further comprises: when the detection circuit detects the duration during which the input voltage is less than the voltage threshold is longer than the time threshold, the reference voltage generation circuit gradually increases the reference voltage to a predetermined reference voltage within the hold-up time according to the detection result.

10. The operating method according to claim 7, wherein the operating method further comprises: when the detection circuit detects the duration during which the input voltage is less than the voltage threshold is shorter than or equal to the time threshold, and the reference voltage generation circuit detects that the output voltage is decreased according to the feedback signal generated by the feedback circuit, the reference voltage generation circuit increases the reference voltage, and the control signal generated by the control signal generation circuit accordingly controls the power conversion circuit to increase the output voltage.

11. The operating method according to claim 7, wherein the operating method further comprises: when the detection circuit detects the duration during which the input voltage is less than the voltage threshold is shorter than or equal to the time threshold, and the reference voltage generation circuit detects that the output voltage is increased according to the feedback signal generated by the feedback circuit, the reference voltage generation circuit decreases the reference voltage, and the control signal generated by the control signal generation circuit accordingly controls the power conversion circuit to decrease the output voltage.
